(19) United States
(12) Patent Application Publication
(10) Pub. No.: US 2004/0046336 A1
(43) Pub. Date: Mar. 11, 2004

(54) Vehicle suspension system having a torsion spring assembly

(76) Inventors: Eric L. Jensen, Dayton, OH (US); Todd A. Bishop, Centerville, OH (US); William C. Kruckemeyer, Beavercreek, OH (US); Mark O. Bodie, Dayton, OH (US); David J. Barta, Beavercreek, OH (US)

Correspondence Address: Scott A. McBain, Delphi Technologies, Inc., Legal Staff - M/C 480-410-202, P.O. Box 5052, Troy, MI, 48007, US

(21) Appl. No.: 10/644,175

(22) Filed: Aug. 20, 2003

Related U.S. Application Data
(60) Provisional application No. 60/405,136, filed on Aug. 21, 2002.

(51) Int. Cl. B60G 17/01

(52) U.S. Cl. 280/5.511

(57) ABSTRACT

A suspension system for a vehicle. A control arm is attachable to the vehicle frame by a first bushing and by a second bushing and is attachable to the knuckle by a ball joint. A torsion spring assembly has a torsion tube and a torsion bar positioned within the torsion tube. A first end portion of the torsion bar is attached to a first end portion of the torsion tube, and a second end portion of the torsion bar extends beyond a second end of the torsion tube and is attached to the control arm. No portion of the torsion tube is immobilized with respect to the frame. A moment bar has a first end portion attached to the torsion tube and has a second end portion attachable to the frame.

### CROSS REFERENCE TO RELATED APPLICATIONS

The present application claims priority of U.S. Provisional Application No. 60/405,136 filed Aug. 21, 2002, the entire disclosure of which is incorporated herein by reference.

### TECHNICAL FIELD

The present invention relates generally to vehicle suspension systems, and more particularly to a vehicle suspension system having a torsion spring assembly.

### BACKGROUND OF THE INVENTION

Conventional vehicle suspension systems include those having a vehicle suspension system lower control arm and a torsion spring assembly. The lower control arm has a first portion attached to the vehicle frame by a first bushing, a second portion attached to the frame by a second bushing, and a third portion attached to a knuckle by a ball joint. The torsion spring assembly includes a torsion tube and a torsion bar disposed within and radially spaced apart from the torsion tube. A first end of the torsion bar is attached to a first end of the torsion tube. A second end of the torsion bar extends beyond a second end of the torsion tube and is attached to the first bushing. The first or second end of the torsion tube is immobilized with respect to the vehicle frame to react torsional forces by being rigidly attached to the vehicle frame. A rotary damper assembly is operably connected to the torsion tube and the torsion bar. The vehicle has a lower control arm, an upper control arm, a torsion spring assembly, and a rotary damper assembly for each wheel. Such a vehicle suspension system carries spring vibrations to the occupants of the vehicle, as can be appreciated by those skilled in the art.

What is needed is an improved vehicle suspension system having a torsion spring assembly.

### SUMMARY OF THE INVENTION

In a first expression of an embodiment of the invention, a suspension system for a vehicle includes a vehicle suspension system control arm, a torsion spring assembly, and a moment bar. The vehicle has a knuckle and a frame. The vehicle suspension system control arm has a first portion attachable to the frame by a first control-arm bushing, has a second portion attachable to the frame by a second control-arm bushing, and has a third portion attachable to the knuckle by a ball joint. The torsion spring assembly has a torsion tube and a torsion bar positioned within the torsion tube. A first end portion of the torsion bar is attached to a first end portion of the torsion tube, a second end portion of the torsion bar extend portions beyond a second end of the torsion tube and is attached to the control arm, and no portion of the torsion tube is immobilized with respect to the frame. The moment bar has a first end portion attached to the torsion tube and has a second end portion attachable to the frame.

A second expression of an embodiment of the invention is identical to the above first expression with the addition of a rotary damper assembly which is operably connected to the torsion tube and the torsion bar.

A third expression of an embodiment of the invention is identical to the above first expression with the addition of a controllable rotary damper assembly which is operably connected to the torsion tube and the torsion bar and which is operably connectable to an electronic control unit of a vehicle suspension control system.

Several benefits and advantages are derived from one or more of the expressions of an embodiment of the invention. Having a damper assembly, having no portion of the torsion tube be immobilized with respect to the frame, and having a moment bar with a first end portion attached to the torsion tube and a second end portion attachable to the frame lessens the effect of spring vibrations on the occupants of the vehicle. Having, in one example, the second end portion of the moment bar be attached to the torsion tube of an additional torsion spring assembly allows the torque on the moment bar from one side of the vehicle to be reacted by the other side of the vehicle through the additional torsion spring assembly and an additional rotary damper assembly of the other side of the vehicle greatly reducing the effect of spring vibrations on the occupants of the vehicle. Having the rotary damper assembly be a controllable rotary damper assembly provides controllable vehicle suspension while reducing the effect of spring vibrations on the occupants of the vehicle.

### SUMMARY OF THE DRAWINGS

FIG. 1 is a schematic top planar view of an embodiment of the suspension system of the invention including a front-left-side lower control arm, a front-right-side lower control arm, and a moment bar;

FIG. 2 is longitudinal cross-sectional view of a portion of the suspension system of FIG. 1 including a portion of the front-left-side lower control arm;

FIG. 3 is an exploded perspective view of a portion of the suspension system of FIG. 1 including the front-left-side lower control arm and the addition of a front-left-side upper control arm; and

FIG. 4 is a longitudinal cross-sectional view of an alternate embodiment of the moment bar of FIG. 1.

### DESCRIPTION OF THE PREFERRED EMBODIMENT

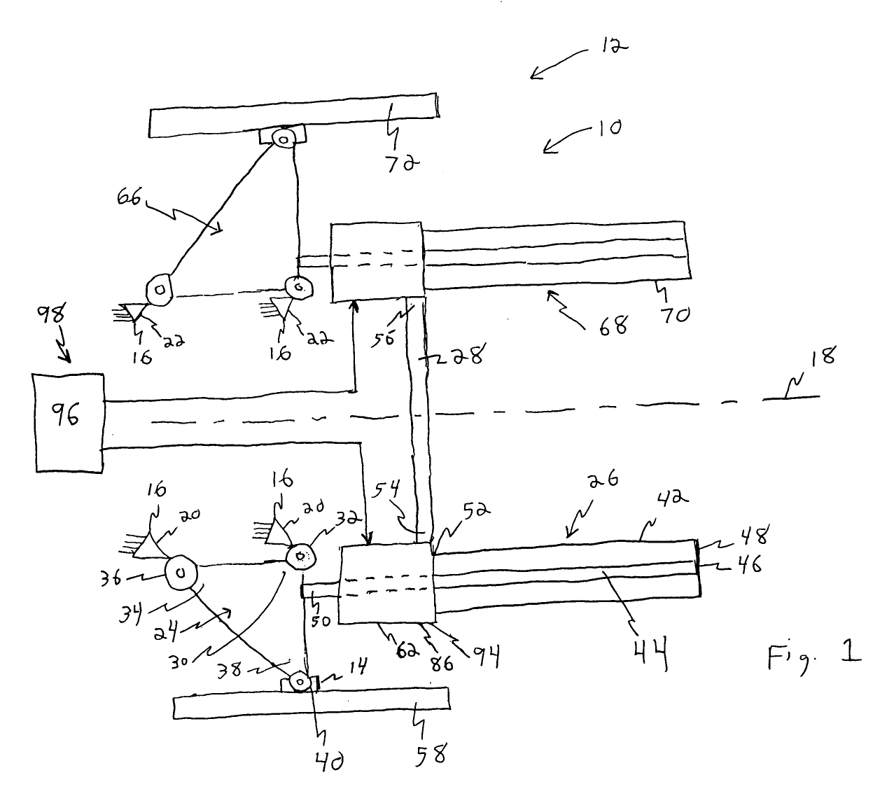

Referring now to the drawings, wherein like numerals represent like elements throughout, FIGS. 1-3 show an embodiment of the present invention. A first expression of the embodiment of FIGS. 1-3 is for a suspension system 10 for a vehicle 12, wherein the vehicle 12 has a knuckle 14 and a frame 16. Only a portion or portions of the vehicle 12 and the frame 16 are shown in the figures. The suspension system 10 includes a vehicle suspension system control arm 24, a torsion spring assembly 26, and a moment bar 28. The control arm 24 has a first portion 30 attachable to the frame 16 by a first control-arm bushing 32, has a second portion 34 attachable to the frame 16 by a second control-arm bushing 36, and has a third portion 38 attachable to the knuckle 14 by a ball joint 40. The torsion spring assembly 26 has a torsion tube 42 and a torsion bar 44 disposed within the torsion tube 42. A first end portion 46 of the torsion bar 44 is attached to a first end portion 48 of the torsion tube 42. A second end portion 50 of the torsion bar 44 extend portions beyond a second end 52 of the torsion tube 42 and is attached to the control arm 24. No portion of the torsion tube 42 is immobilized with respect to the frame 16. The moment bar 28 has a first end portion 54 attached to the torsion tube 42 and has a second end portion 56 attachable to the frame 16. It is noted that the term “attached” includes directly attached or indirectly attached, and that the term “attachable” includes directly attachable or indirectly attachable.

In one example of the first expression of the embodiment of FIGS. 1-3, the vehicle 12 has a longitudinal axis 18 dividing the frame 16 into a first side 20 and a second side 22, wherein the first portion 30 is attachable to the first side 20 by the first control-arm bushing 32, and wherein the second portion 34 is attachable to the first side 20 by the second control-arm bushing 36. The longitudinal axis 18 runs front to back through the middle of the vehicle dividing it into a left half and a right half. The expression “first side” includes any and all portions of the vehicle frame that are located to one side (e.g., the left or the right) of the longitudinal axis. Likewise, the expression “second side” includes any and all portions of the vehicle frame that are located to the other side of the longitudinal axis.

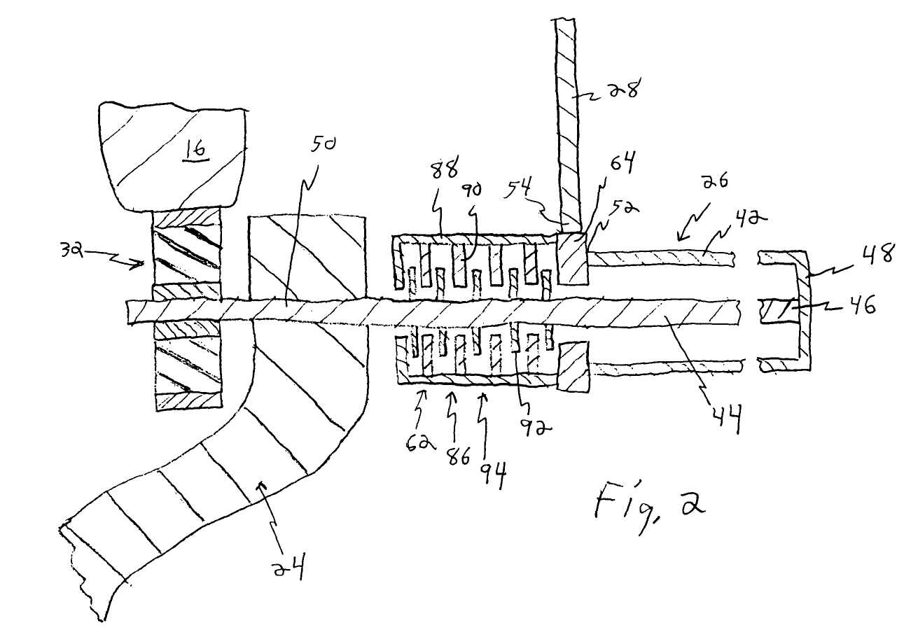

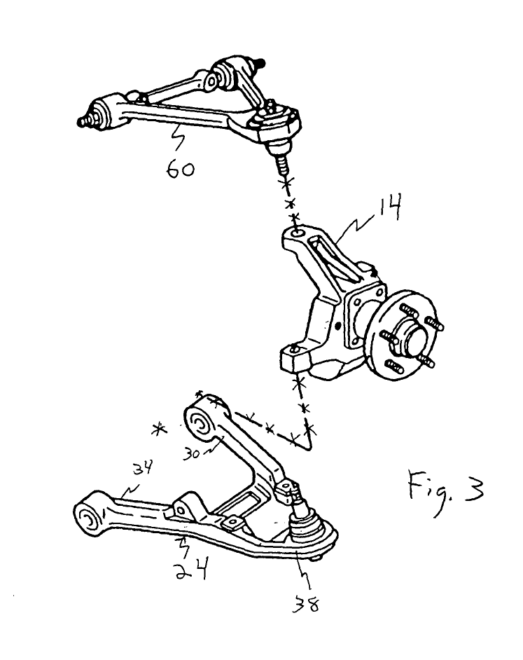

In one arrangement of the first expression of the embodiment of FIGS. 1-3, the knuckle 14 is associated with the left-front wheel 58 of the vehicle 12. In one assemblage, the suspension system 10 also includes a vehicle suspension system same-side control arm 60 (seen only in FIG. 3) which is attachable to the knuckle 14. In one variation, a damper assembly 62 is operably connected to the control arm 24 (seen in FIGS. 1 and 2) or the same-side control arm 60 (seen only in FIG. 3). In one modification, the control arm 24 is a lower control arm, and the same-side control arm 60 is an upper control arm. In one design, the moment bar 28 is a substantially transversely extending moment bar, and the first end portion 54 of the moment bar 28 is attached to the torsion tube 42 proximate the second end 52 of the torsion tube 42 (such as being indirectly attached via a connecting member 64).

In one enablement of the first expression of the embodiment of FIGS. 1-3, the suspension system 10 includes a vehicle suspension system additional control arm 66 which is a substantial mirror image about the longitudinal axis 18 of the control arm 24. In this enablement, the suspension system 10 also includes an additional torsion spring assembly 68 which is a substantial mirror image about the longitudinal axis 18 of the torsion spring assembly 26. In this enablement, the second end portion 56 of the moment bar 28 is indirectly attached to the second side 22 by being attached to the torsion tube 70 of the additional torsion spring assembly 68. The vehicle's right-front wheel 72 is shown in FIG. 1 in association with the additional control arm 66.

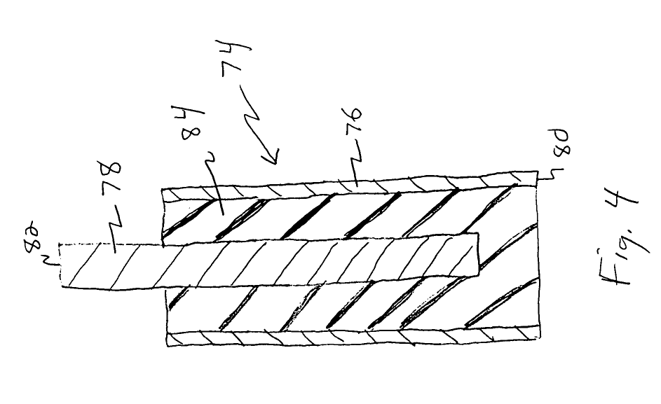

In one construction of the first expression of the embodiment of FIGS. 1-3, the moment bar 28, shown in FIGS. 1 and 2, is not a telescoping moment bar and has no outer portion and slideable inner portion. FIG. 4 shows an alternate embodiment of a moment bar 74. In FIG. 4, the moment bar 74 includes an outer portion 76 and an inner portion 78 disposed coaxially and slideably within the outer portion 76. In this embodiment, the first end portion 80 of the moment bar 74 is an end portion of the outer portion 76, and the second end portion 82 of the moment bar 74 is an end portion of the inner portion 78. In one variation, the moment bar 74 includes an elastomer 84 disposed between the inner and outer portions 78 and 76. In one modification, the elastomer 84 forms a press fit with the inner and outer portions 78 and 76.

In one illustration of the first expression of the embodiment of FIGS. 1-3, the torsion tube 42 and the moment bar 28 lie substantially in a horizontal plane when the vehicle 12 is horizontal. In one variation, the torsion spring assembly 26 and the additional torsional spring assembly 68 are associated with the corresponding left and right front wheels 58 and 72 of the vehicle 12, are substantially parallel to the longitudinal axis 18, and extend toward the rear of the vehicle 12 as shown in FIG. 1.

A second expression of the embodiment of FIGS. 1-3 is for a suspension system 10 for a vehicle 12, wherein the vehicle 12 has a knuckle 14 and a frame 16. The suspension system 10 includes a vehicle suspension system control arm 24, a torsion spring assembly 26, a moment bar 28, and a rotary damper assembly 86. The control arm 24 has a first portion 30 attachable to the frame 16 by a first control-arm bushing 32, has a second portion 34 attachable to the frame 16 by a second control-arm bushing 36, and has a third portion 38 attachable to the knuckle 14 by a ball joint 40. The torsion spring assembly 26 has a torsion tube 42 and a torsion bar 44 disposed within the torsion tube 42. A first end portion 46 of the torsion bar 44 is attached to a first end portion 48 of the torsion tube 42. A second end portion 50 of the torsion bar 44 extends beyond a second end 52 of the torsion tube 42 and is attached to the control arm 24. No portion of the torsion tube 42 is immobilized with respect to the frame 16. The moment bar 28 has a first end portion 54 attached to the torsion tube 42 and has a second end portion 56 attachable to the frame 16. The rotary damper assembly 86 is operably connected to the torsion tube 42 and the torsion bar 44.

In one implementation of the second expression of the embodiment of FIGS. 1-3, the rotary damper assembly 86 includes a cylinder 88 surrounding the torsion bar 44 and attached to the second end 52 of the torsion tube 42 and having radially-inwardly extending plates 90. In this implementation, the rotary damper assembly 86 also includes radially-outwardly extending plates 92 attached to the torsion bar 44 and interleaved with the radially-inwardly extending plates 90. The rotary damper assembly 86 further includes a damping fluid (not shown) and seals (not shown). In one option, the rotary damper assembly 86 is a passive rotary damper assembly (not shown). It is noted that the examples, variations, modifications, etc. of the first expression of the embodiment of FIGS. 1-3 are equally applicable to the second expression.

A third expression of the embodiment of FIGS. 1-3 is for a suspension system 10 for a vehicle 12, wherein the vehicle 12 has a knuckle 14 and a frame 16. The suspension system 10 includes a vehicle suspension system control arm 24, a torsion spring assembly 26, a moment bar 28, and a controllable rotary damper assembly 94. The control arm 24 has a first portion 30 attachable to the frame 16 by a first control-arm bushing 32, has a second portion 34 attachable to the frame 16 by a second control-arm bushing 36, and has a third portion 38 attachable to the knuckle 14 by a ball joint 40. The torsion spring assembly 26 has a torsion tube 42 and a torsion bar 44 disposed within the torsion tube 42. A first end portion 46 of the torsion bar 44 is attached to a first end portion 48 of the torsion tube 42. A second end portion 50 of the torsion bar 44 extends beyond a second end 52 of the torsion tube 42 and is attached to the control arm 24. No portion of the torsion tube 42 is immobilized with respect to the frame 16. The moment bar 28 has a first end portion 54 attached to the torsion tube 42 and has a second end portion 56 attachable to the frame 16. The controllable rotary damper assembly 94 is operably connected to the torsion tube 42 and the torsion bar 44 and is operably connectable to an electronic control unit 96 of a vehicle suspension control system 98 (only the electronic control unit portion of which is shown in the figures).

In one example of the third expression of the embodiment of FIGS. 1-3, the controllable rotary damper assembly 94 is an MR (magnetorheological) rotary damper assembly. Other examples include, without limitation, MSR (manually selectable ride) rotary damper assemblies and RTD (real time damping) rotary damper assemblies. It is noted that the examples, variations, modifications, etc. of the first and/or second expressions of the embodiment of FIGS. 1-3 are equally applicable to the third expression.

Several benefits and advantages are derived from one or more of the expressions of an embodiment of the invention. Having a damper assembly, having no portion of the torsion tube be immobilized with respect to the frame, and having a moment bar with a first end portion attached to the torsion tube and a second end portion attachable to the frame lessens the effect of spring vibrations on the occupants of the vehicle. Having, in one example, the second end portion of the moment bar be attached to the torsion tube of an additional torsion spring assembly allows the torque on the moment bar from one side of the vehicle to be reacted by the other side of the vehicle through the additional torsion spring assembly and an additional rotary damper assembly of the other side of the vehicle greatly reducing the effect of spring vibrations on the occupants of the vehicle. Having the rotary damper assembly be a controllable rotary damper assembly provides controllable vehicle suspension while reducing the effect of spring vibrations on the occupants of the vehicle.

The foregoing description of several expressions and embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

1. A suspension system for a vehicle, wherein the vehicle has a knuckle and a frame, and wherein the suspension system comprises:
a) a vehicle suspension system control arm having a first portion attachable to the frame by a first control-arm bushing, having a second portion attachable to the frame by a second control-arm bushing, and having a third portion attachable to the knuckle by a ball joint;
b) a torsion spring assembly having a torsion tube and a torsion bar disposed within the torsion tube, wherein a first end portion of the torsion bar is attached to a first end portion of the torsion tube, wherein a second end portion of the torsion bar extends beyond a second end of the torsion tube and is attached to the control arm, and wherein no portion of the torsion tube is immobilized with respect to the frame; and
c) a moment bar having a first end portion attached to the torsion tube and having a second end portion attachable to the frame.

2. The suspension system of claim 1, wherein the vehicle has a longitudinal axis dividing the frame into a first side and a second side, wherein the first portion is attachable to the first side by the first control-arm bushing, wherein the second portion is attachable to the first side by the second control-arm bushing, and wherein the second end portion of the moment bar is attachable to the second side.

3. The suspension system of claim 2, including a vehicle suspension system same-side control arm attachable to the knuckle, and including a damper assembly operably connected to the control arm or the same-side control arm.

4. The suspension system of claim 3, wherein the control arm is a lower control arm, and wherein the same-side control arm is an upper control arm.

5. The suspension system of claim 1, wherein the moment bar is a substantially transversely extending moment bar, and wherein the first end portion of the moment bar is attached to the torsion tube proximate the second end of the torsion tube.

6. The suspension system of claim 1, also including a vehicle suspension system additional control arm which is a substantial mirror image about the longitudinal axis of the control arm and including an additional torsion spring assembly which is a substantial mirror image about the longitudinal axis of the torsion spring assembly, and wherein the second end portion of the moment bar is attached to the torsion tube of the additional torsion spring assembly.

7. The suspension system of claim 6, wherein the moment bar includes an outer portion and an inner portion disposed coaxially and slideably within the outer portion, wherein the first end portion of the moment bar is an end portion of the outer portion, and wherein the second end portion of the moment bar is an end portion of the inner portion.

8. The suspension system of claim 7, wherein the moment bar includes an elastomer disposed between the inner and outer portions.

9. The suspension system of claim 1, wherein the torsion tube and the moment bar lie substantially in a horizontal plane when the vehicle is horizontal.

10. A suspension system for a vehicle, wherein the vehicle has a knuckle and a frame, and wherein the suspension system comprises:
a) a vehicle suspension system control arm having a first portion attachable to the frame by a first control-arm bushing, having a second portion attachable to the frame by a second control-arm bushing, and having a third portion attachable to the knuckle by a ball joint;
b) a torsion spring assembly having a torsion tube and a torsion bar disposed within the torsion tube, wherein a first end portion of the torsion bar is attached to a first end portion of the torsion tube, wherein a second end portion of the torsion bar extends beyond a second end of the torsion tube and is attached to the control arm, and wherein no portion of the torsion tube is immobilized with respect to the frame;
c) a moment bar having a first end portion attached to the torsion tube and having a second end portion attachable to the frame; and
d) a rotary damper assembly operably connected to the torsion tube and the torsion bar.

11. The suspension system of claim 10, wherein the vehicle has a longitudinal axis dividing the frame into a first side and a second side, wherein the first portion is attachable to the first side by the first control-arm bushing, wherein the second portion is attachable to the first side by the second control-arm bushing, and wherein the second end portion of the moment bar is attachable to the second side.

12. The suspension system of claim 11, including a vehicle suspension system same-side control arm attachable to the knuckle, and including a damper assembly operably connected to the control arm or the same-side control arm.

13. The suspension system of claim 12, wherein the control arm is a lower control arm, and wherein the same-side control arm is an upper control arm.

14. The suspension system of claim 10 wherein the moment bar is a substantially transversely extending moment bar, and wherein the first end portion of the moment bar is attached to the torsion tube proximate the second end of the torsion tube.

15. The suspension system of claim 10, also including a vehicle suspension system additional control arm which is a substantial mirror image about the longitudinal axis of the control arm and including an additional torsion spring assembly which is a substantial mirror image about the longitudinal axis of the torsion spring assembly, and wherein the second end portion of the moment bar is attached to the torsion tube of the additional torsion spring assembly.

16. The suspension system of claim 15, wherein the moment bar includes an outer portion and an inner portion disposed coaxially and slideably within the outer portion, wherein the first end portion of the moment bar is an end portion of the outer portion, and wherein the second end portion of the moment bar is an end portion of the inner portion.

17. The suspension system of claim 16, wherein the moment bar includes an elastomer disposed between the inner and outer portions.

18. The suspension system of claim 10, wherein the torsion tube and the moment bar lie substantially in a horizontal plane when the vehicle is horizontal.

19. A suspension system for a vehicle, wherein the vehicle has a knuckle and a frame, and wherein the suspension system comprises:
a) a vehicle suspension system control arm having a first portion attachable to the frame by a first control-arm bushing, having a second portion attachable to the frame by a second control-arm bushing, and having a third portion attachable to the knuckle by a ball joint;
b) a torsion spring assembly having a torsion tube and a torsion bar disposed within the torsion tube, wherein a first end portion of the torsion bar is attached to a first end portion of the torsion tube, wherein a second end portion of the torsion bar extends beyond a second end of the torsion tube and is attached to the control arm, and wherein no portion of the torsion tube is immobilized with respect to the frame;
c) a moment bar having a first end portion attached to the torsion tube and having a second end portion attachable to the frame and
d) a controllable rotary damper assembly operably connected to the torsion tube and the torsion bar and operably connectable to an electronic control unit of a vehicle suspension control system.

20. The suspension system of claim 19, wherein the controllable rotary damper assembly is a magnetorheological rotary damper assembly.
